(19) United States
(12) Patent Application Publication
(10) Pub. No.: US 2022/0138864 A1
(43) Pub. Date: May 5, 2022

(54) INFERRING ITEM-LEVEL DATA WITH BACKWARD CHAINING RULE-BASED REASONING SYSTEMS

(71) Applicant: Capital One Services, LLC, McLean, VA (US)

(72) Inventors: Joshua EDWARDS, Philadelphia, PA (US); Michael MOSSOBA, Arlington, VA (US); Abdelkader M'Hamed BENKREIRA, New York, NY (US)

(21) Appl. No.: 17/087,122

(22) Filed: Nov. 2, 2020

(51) Int. Cl. G06Q 40/00; G06F 16/23; G06Q 30/04; G06Q 30/02; G06Q 20/42; G06Q 30/00; G06Q 10/08; G06Q 20/08; G06N 5/04; G06N 20/00

(52) U.S. Cl. CPC G06Q 40/12; G06F 16/2365; G06Q 30/04; G06Q 30/0205; G06N 20/00; G06Q 30/012; G06Q 10/087; G06Q 20/085; G06N 5/04; G06Q 20/42

(57) ABSTRACT

A rule-based reasoning system may receive first transaction-level data for a first transaction that indicates a first transaction amount of the first transaction and a first merchant associated with the first transaction. The system may determine first item-level data for the first transaction that indicates one or more line items associated with the first transaction. The system may infer second item-level data for a second transaction based on the first item-level data and based on: a determination that a second merchant, associated with the second transaction, matches the first merchant associated with the first transaction, and a determination that a second transaction amount, associated with the second transaction, matches the first transaction amount or satisfies a condition that is based on a calculation performed using the first transaction amount and the second transaction amount. The system may output an indication of the second item-level data associated with the second transaction.

### BACKGROUND

A system may receive transaction-level data using a computer network. However, unless another data source, such as a user, provides item-level data for a specific transaction, the transaction-level data has low granularity.

### SUMMARY

In some implementations, a method includes: receiving, by a system, first transaction-level data for a first transaction, wherein the first transaction-level data indicates a first transaction amount of the first transaction and a first merchant associated with the first transaction; determining, by the system, first item-level data for the first transaction, wherein the first item-level data indicates one or more line items associated with the first transaction; inferring, by the system, second item-level data for a second transaction based on the first item-level data and based on: a determination that a second merchant, associated with the second transaction, matches the first merchant associated with the first transaction, and a determination that a second transaction amount, associated with the second transaction, matches the first transaction amount or satisfies a condition that is based on a calculation performed using the first transaction amount and the second transaction amount; and outputting, by the system, an indication of the second item-level data associated with the second transaction.

In some implementations, a system includes one or more memories and one or more processors, communicatively coupled to the one or more memories, configured to: receive first transaction-level data for a first transaction, wherein the first transaction-level data indicates a first transaction amount of the first transaction, a first merchant associated with the first transaction, and a first geographic region associated with the first transaction; identify a second transaction based on a determination that a second merchant associated with the second transaction, a second transaction amount associated with the second transaction, and a second geographic region associated with the second transaction satisfy a condition that is based on the first merchant, the first transaction amount, and the first geographic region; infer second item-level data associated with the second transaction based on first item-level data associated with the first transaction; and output an indication of the second item-level data associated with the second transaction.

In some implementations, a non-transitory computer-readable medium storing a set of instructions includes one or more instructions that, when executed by one or more processors of a system, cause the system to: receive first transaction-level data and first item-level data for a first transaction, wherein the first transaction-level data indicates a first transaction amount of the first transaction and a first merchant associated with the first transaction, and wherein the first item-level data indicates one or more line items associated with the first transaction; receive second transaction-level data for a second transaction, wherein the second transaction-level data indicates a second transaction amount of the second transaction and a second merchant associated with the second transaction; infer second item-level data for the second transaction based on the first item-level data and based on a determination that a condition, that is based on the first transaction-level data and the second transaction-level data, is satisfied; and output an indication of the second item-level data inferred for the second transaction.

### BRIEF DESCRIPTION OF THE DRAWINGS

FIGS. 1A-1B are diagrams of an example implementation described herein.

FIGS. 2A-2B are diagrams of example data for use in systems and/or methods described herein.

FIG. 3 is a diagram illustrating example inference rules for use in systems and/or methods described herein.

FIG. 4 is a diagram illustrating an example of training and using a machine learning model for use in systems and/or methods described herein.

FIG. 5 is a diagram of an example environment in which systems and/or methods described herein may be implemented.

FIG. 6 is a diagram of example components of one or more devices of FIG. 5.

FIG. 7 is a flowchart of an example process relating to inferring item-level data using backward chaining rule-based reasoning systems.

### DETAILED DESCRIPTION

The following detailed description of example implementations refers to the accompanying drawings. The same reference numbers in different drawings may identify the same or similar elements.

A transaction storage system may receive transaction-level data from a terminal or another data source, and the transaction storage system may store the transaction-level data. This transaction-level data often does not include item-level data, such as specific products or services that were exchanged in a transaction. As a result, information stored in the transaction storage system may lack detail and completeness, making the information in the transaction storage system less useful than if the transaction storage system also stored item-level data. In some cases, item-level data may be provided to the transaction storage system from another data source, such as a user device or inventory record, but this item-level data may map to only some transaction-level data. Accordingly, the transaction storage system may still lack detail and completeness even when information from the transaction storage system is paired with information from a data source that stores item-level data.

Some implementations described herein provide an inferencing system that infers item-level data for a transaction despite item-level data for that transaction not being provided to the transaction storage system. According to some implementations, the inferencing system obtains transaction-level data for a first transaction and item-level data for the first transaction and then infers item-level data for a second transaction using rule-based reasoning that is applied to the transaction-level data and the item-level data for the first transaction. In some implementations, the inferencing system uses backward chaining by identifying and refining rules to infer item-level data for transactions where item-level data is unavailable. Backward chaining is an artificial intelligence technique in which an inferencing system applies logical rules to known information to infer new information by starting with an end result and working backward through various rules to determine information that supports the end result. According to some implementations described herein, backward chaining is used to apply rules to transaction-level data to infer item-level data that resulted in the transaction-level data. According to some implementations, the inferencing system uses one or more machine learning models for the rules.

In some cases, a user may take a picture of a receipt for a transaction, and may upload the picture to a system that performs optical character recognition (OCR) on the receipt to determine item-level data for the transaction. However, this technique may be error-prone due to inaccuracies of OCR, particularly in scenarios where the picture quality is poor, the entire receipt is not captured in the picture (e.g., for a long receipt), or the ink on the receipt is smudged or is not dark enough for accurate OCR. Some implementations described herein enable a more accurate determination of item-level data in these scenarios. Furthermore, the technique of determining item-level data for a transaction by performing OCR on a receipt requires a receipt to be provided for the transaction, which is often not done. Some implementations described herein enable the item-level data to be determined for a transaction even if a receipt is not provided for the transaction, resulting in more detailed and complete transaction information. Furthermore, some implementations described herein are less computationally complex (e.g., requiring fewer computing resources, such as processor resources, memory resources, and/or image processing resources) than performing OCR.

Some implementations described herein may provide greater detail, completeness, and granularity to transaction data by generating item-level data that is otherwise unavailable for a transaction and/or that is more accurate than some item-level data generated using other techniques (e.g., due to the issues with OCR described above). This improves the usefulness of the transaction storage system because item-level data can be used for a variety of purposes, described in more detail elsewhere herein. Furthermore, implementations described herein may provide flexibility to reconfigure and recalibrate inference rules over time. Accordingly, the inference rules described herein may provide better inferences over time without user intervention. In some cases, inferred item-level data may used for fraud detection, which can improve security and conserve resources otherwise used to identify and/or correct fraud.

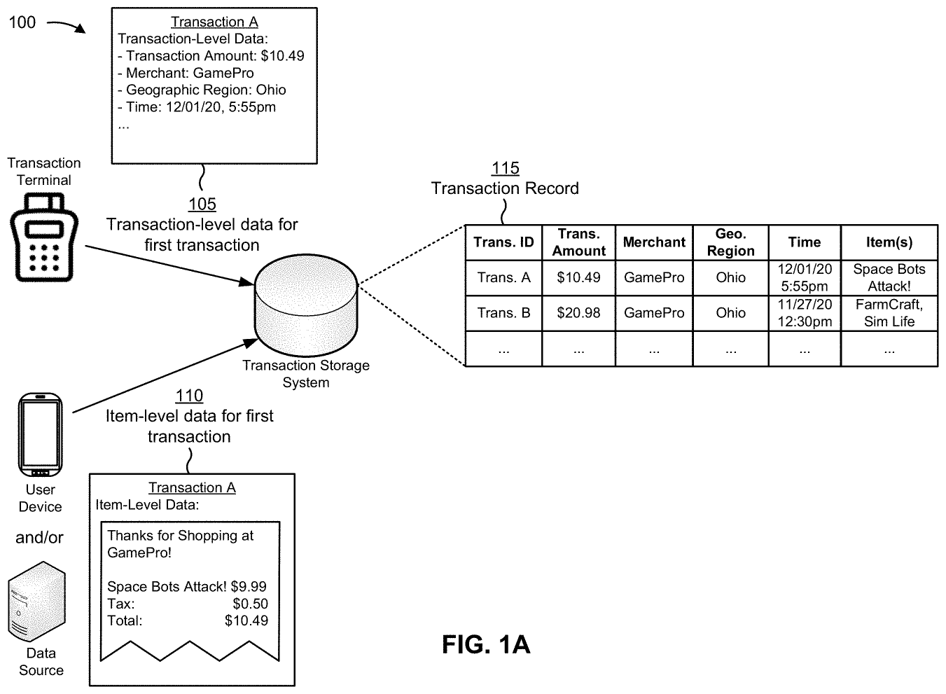

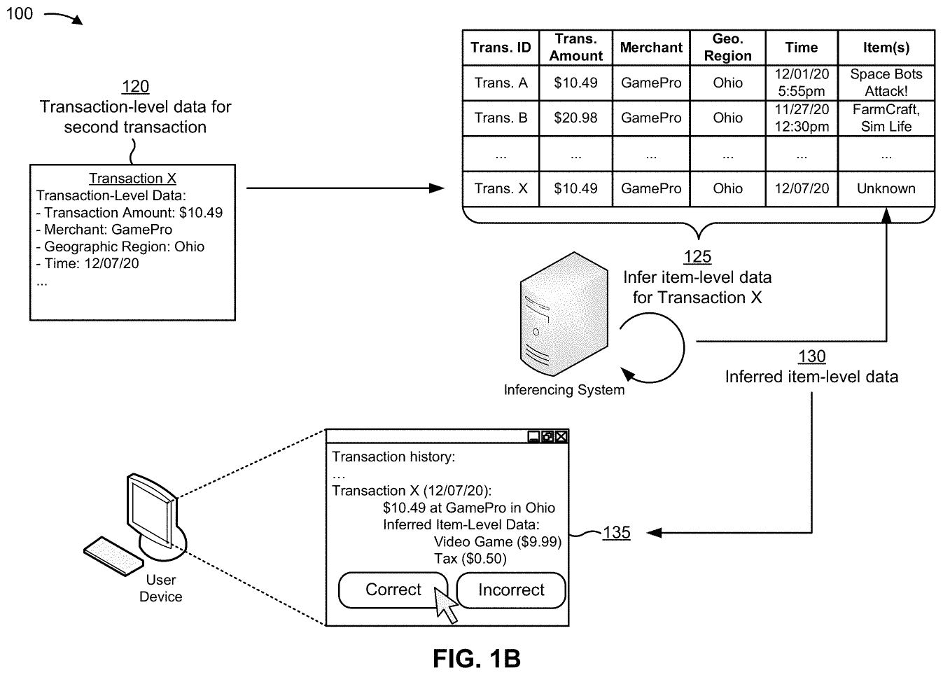

FIGS. 1A-1B are diagrams of an example 100 associated with an inferencing system for obtaining item-level transaction data. In some implementations, the inferencing system may use rule-based reasoning (e.g., backward chaining) to determine item-level data when that item-level data is otherwise unavailable. As shown in FIGS. 1A-1B, example 100 includes a transaction storage system that receives information from a user device and/or another data source and provides that information to an inferencing system for inferring item-level data.

As shown by reference number 105, the transaction storage system may receive first transaction-level data for a first transaction. In some implementations, the transaction storage system may receive the first transaction-level data from a transaction terminal via a network. As further shown in FIG. 1A, transaction-level data for a transaction (shown as Transaction A) may indicate a transaction amount of a transaction (shown as a first transaction amount of $10.49 for the first transaction), a merchant associated with the transaction (shown as a first merchant of “GamePro” for the first transaction), a geographic region associated with the first transaction (shown as “Ohio”), and/or a time associated with the first transaction (shown as 12/01/20, 5:55 pm), a transaction identifier that identifies the transaction, a payment method used for the transaction, Level 1 transaction data (e.g., a card number, a date, a card verification value, a zip code, a merchant name, and/or a transaction amount), Level 2 transaction data (e.g., Level 1 data plus an indication of sales tax, a customer code, and/or a purchase identifier).

The above transaction-level data may be indicated in a variety of formats. For example, the transaction amount may indicate a dollar amount (or an amount in another currency) of the entire transaction (e.g., all items purchased plus sales tax). The merchant may be indicated using a merchant name and/or a merchant identifier. The geographic region may be indicated by an address (e.g., of the merchant), a location identifier associated with the merchant, a postal code, a country name or identifier, a state name or identifier, a province name or identifier, a region name or identifier, and/or a physical address, among other examples. For example, the geographic region may be a particular store location and/or a geographic area in which the store is located. The time may include a date, a time of day, and/or a day of the week, among other examples.

As shown by reference number 110, the transaction storage system may determine first item-level data for the first transaction. In some implementations, the transaction storage system may receive the first item-level data from a user device or another data source via a network. For example, the transaction storage system may receive an image, a file, a text string, or another data structure encoding the first item-level data. The user device or other data source may have applied OCR to the data structure to obtain strings or other machine-interpretable versions of information indicated by the first item-level data. Additionally, or alternatively, the transaction storage system may apply OCR to an image stored in the data structure to obtain or verify the strings or other machine-interpretable versions of information indicated by the first item-level data. For example, the user device may obtain an image of a receipt generated based on the first transaction, and may perform OCR on the receipt to identify the item-level data. Alternatively, the user device may transmit the image to the data source (or directly to the transaction storage system), which may then perform OCR on the image and provide the resulting item-level data to the transaction storage system. In some cases, a user may be incentivized to provide a receipt with item-level data.

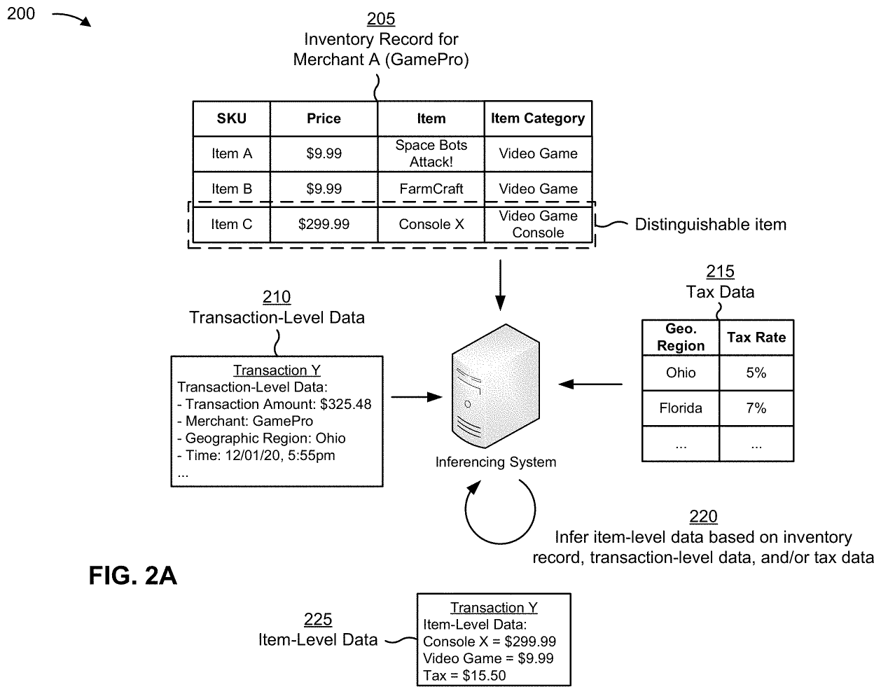

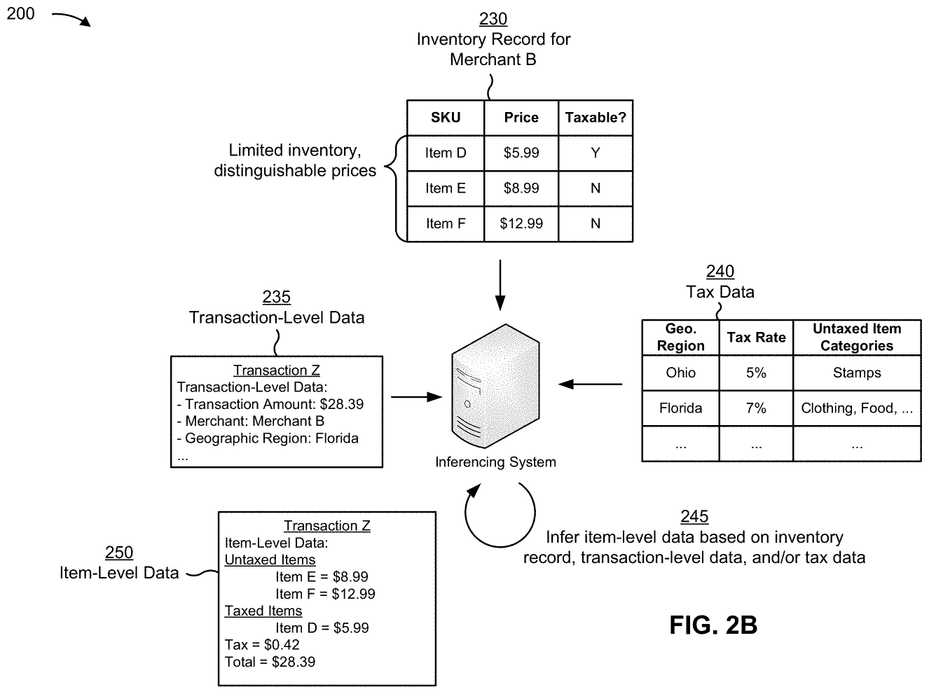

Additionally, or alternatively, the transaction storage system may receive the first item-level data from another data source, such as an inventory system (described below in connection with FIGS. 2A-2B), and/or a manufacturer system that received the first item-level data while processing a coupon redemption from the merchant, among other examples. Additionally, or alternatively, the transaction storage system may receive the item-level data from the transaction terminal, such as when the transaction terminal is associated with a merchant that provides Level 3 transaction data, such as line-item data or item-level data.

As shown in FIG. 1A, item-level data may indicate one or more line items associated with a transaction and/or corresponding price(s) for those one or more line items. For example, a line item may identify a product, a product category, a service, a service category, and/or a tax (e.g., a sales tax) along with a corresponding price (e.g., a cost or amount) for that line item. In example 100, a product is identified by a product name (a video game called “Space Bots Attack!”) but may also be indicated by a category, a product identifier, and/or a stock keeping unit (SKU), among other examples. In example 100, first item-level data for the first transaction indicates a first line item of a video game called “Space Bots Attack!” and a price of $9.99 for the first line item, and also indicates a second line item of sales tax with a price of $0.50.

As shown by reference number 115, the transaction storage system may associate the first transaction-level data and the first item-level data in a transaction record. In some implementations, the transaction storage system may determine that the first transaction-level data and the first item-level data are associated with one another based on a match between transaction identifiers, transaction amounts, merchants, geographic regions, and/or times, among other examples. Additionally, or alternatively, the transaction storage system may associate the first item-level data and the first transaction-level data using one or more rules, as described below in connection with FIGS. 2A-2B.

As shown, the transaction storage system may store the first item-level data in connection with the first transaction level data. In example 100, data for the first transaction is stored using a transaction identifier of Transaction A, and indicates a transaction amount of “$10.49”, a merchant of “GamePro”, a geographic region of “Ohio”, a time of “12/01/20 at 5:55 pm”, and item-level data that indicates that an item called “Space Bots Attack!” was purchased in the first transaction. As another example, data for another transaction is shown as being stored using a transaction identifier of Transaction B, and indicates a transaction amount of “$20.98”, a merchant of “GamePro”, a geographic region of “Ohio”, a time of “11/27/20 at 12:30 pm”, and item-level data that indicates that two items, identified as “FarmCraft” and “Sim Life”, were purchased in the transaction.

As shown in FIG. 1B, and by reference number 120, the transaction storage system may receive second transaction-level data for a second transaction (Transaction X), in a similar manner as described above in connection with reference number 105 of FIG. 1A. The second transaction-level data may include data described above, also in connection with reference number 105 of FIG. 1A. As shown, the second transaction-level data indicates a transaction amount of the second transaction (shown as “$10.49”), a merchant associated with the second transaction (shown as “GamePro”), a geographic region associated with the second transaction (shown as “Ohio”), and a time associated with the second transaction (shown as “12/07/20”), among other examples. As shown, the transaction storage system may store the second transaction level data. In this example, the transaction storage system has not received item-level data for the second transaction, and the transaction storage system stores an indication that item-level data is not known for the second transaction (shown as “Unknown”).

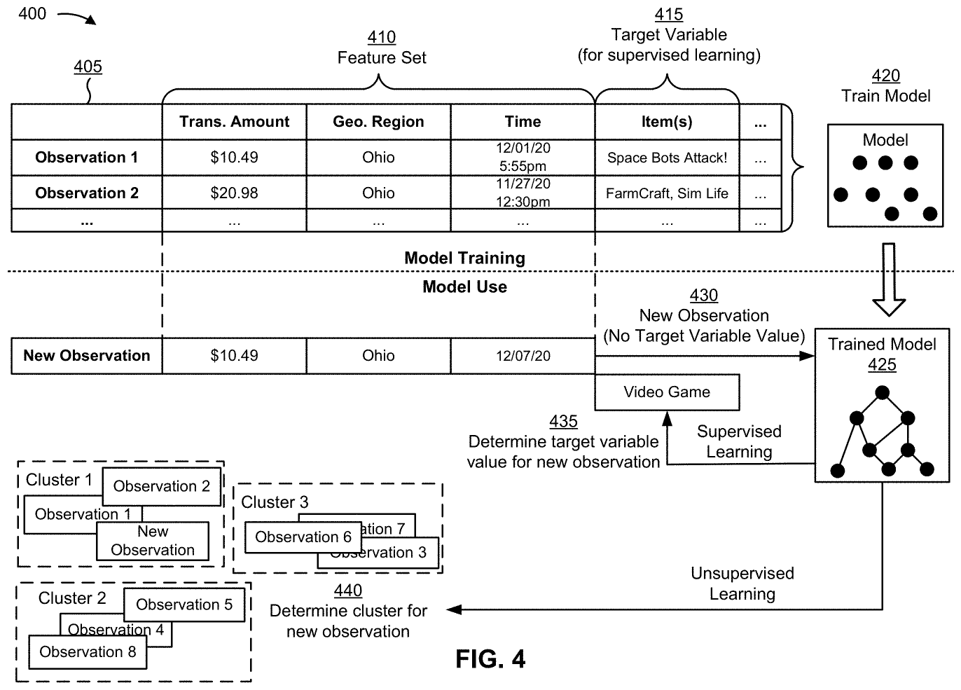

As shown by reference number 125, an inferencing system may infer second item-level data for the second transaction (Transaction X) based on first item-level data for a first transaction (Transaction A). The inferencing system may receive or obtain transaction records from the transaction storage system, or may be implemented by the transaction storage system. In some implementations, the inferencing system may apply rule-based reasoning to infer the second item-level data. For example, the inferencing system may determine one or more rules based on an association between the first item-level data and the first transaction-level data (e.g., as described above) with the goal of inferring second item-level data associated with the second transaction-level data. The inferencing system may refine the one or more rules over time based on receiving additional transaction-level data and corresponding item-level data (described in more detail below) and/or based on feedback from one or more users (e.g., as described below in connection with reference number 135). For example, the inferencing system may use one or more machine-learned models as described below in connection with FIG. 4.

In some implementations, the inferencing system may apply one or more rules to determine that the second item-level data can be inferred from the first item-level data. An example rule is that a second merchant, associated with the second transaction, matches a first merchant associated with the first transaction (e.g., an exact match or a fuzzy match). Another example rule is that a second transaction amount, associated with the second transaction, matches a first transaction amount (associated with the first transaction) or satisfies a condition that is based on a calculation performed using the first transaction amount and the second transaction amount. For example, the condition may be that the second transaction amount is a multiple of or a divisor of the first transaction amount after accounting for tax (e.g., after subtracting a first tax amount from the first transaction amount and subtracting a second tax amount from the second transaction amount). The tax amounts may be received in transaction-level data, may be received in item-level data (e.g., for one of the transactions), and/or may be determined using tax data that includes, for example, a tax rate for a geographic region and/or information that identifies taxed (or taxable) and untaxed (or untaxable) items or item categories for a geographic region.

Another example rule is that a second geographic region, associated with the second transaction, matches a first geographic region associated with the first transaction or satisfies a condition associated with the first geographic region (e.g., one of the geographic regions is located within the other geographic region and/or the geographic regions are less than or equal to a threshold distance from one another). Another example rule is that a second transaction time, associated with the second transaction, satisfies a condition associated with a first transaction time of the first transaction. For example, the condition may be an exact match between the first and second transaction times (e.g., encoded in universal coordinated time (UCT)), the two transaction times being within a threshold amount of time of one another (e.g., the transactions occurred on the same day, within 48 hours of one another, within the same week, within the same month, within a range of dates, and/or within a range of times), the second transaction time and the first transaction time being within a same time range (e.g., a same time range on different days). For example, the inferencing system may use a database storing information associated with the first merchant and/or the second merchant to identify the one or more time ranges, such as a happy hour time range or another time range that may be associated with one or more differences in item-level data (e.g., different prices).

As an example, because Transaction A, for which item-level data was received, and Transaction X, for which item-level data was not received, are associated with the same transaction amount ($10.49), the same merchant (GamePro), the same geographic region (Ohio), and occurred within a threshold time range (e.g., one week), the inferencing system may infer item-level data for Transaction X from the item-level data for Transaction A. In some cases, if the inference is based on a single transaction, then the inferencing system may infer that the item-level data for Transaction X is “Space Bots Attack!” or that the item-level data has a same product category of “Space Bots Attack! (e.g., a product category of Video Game). In some implementations, the inferencing system may use multiple transactions to infer item-level data for Transaction X. For example, Transaction B, for which item-level data was received, has a transaction amount that is a multiple of the transaction amount of Transaction X (e.g., $20.98=$10.49×2), is associated with the same merchant and geographic region, and has a time range that satisfies a threshold (in this case, two weeks). Because two video games were purchased in Transaction B (e.g., FarmCraft and Sim Life), the inferencing system may infer that each of these video games cost $10.49, and may use this information (e.g., in combination with the item-level data for Transaction A) to infer that the item-level data for Transaction X includes a video game with a price of $9.99 and a tax amount of $0.50. Other example rules and techniques for inferring item-level data are described below in connection with FIGS. 2A and 2B.

In some implementations, a second transaction for which item-level data is inferred may be associated with a different account (e.g., a second account) than an account (e.g., a first account) associated with a first transaction that includes item-level data used to infer the item-level data for the second transaction. This enables inferencing of more item-level data and with potentially greater confidence (accuracy) in some scenarios (e.g., due to accounting for a larger quantity of transactions) than if inferencing of item-level data were limited to using transactions on the same account as input for the inferencing. Alternatively, the first transaction and the second transaction may be associated with the same account (e.g., the same credit card number and/or bank account). This may enable better accuracy in some scenarios due to inferences that are based on behaviors of a particular accountholder. In some implementations, the first transaction and the second transaction may be associated with accounts that share a threshold degree of similarity, which may be calculated based on demographic information of accountholders of the accounts and/or similarities in purchase behavior associated with the accounts, among other examples.

In some implementations, the inferencing system may receive OCR data obtained by performing OCR on an image of a receipt for the second transaction and/or may perform OCR on such an image to obtain OCR data. In some cases, the OCR data may be inaccurate, such as when the image quality is poor, the entire receipt is not captured in the image (e.g., for a long receipt), and/or the ink on the receipt is smudged or is not dark enough for accurate OCR. The inferencing system may use the OCR data as input when inferring the item-level data for the second transaction, which may result in a more accurate inference than if the inferencing system were not to use the OCR data or if the inferencing system were to use only the OCR data without the inferencing techniques described herein.

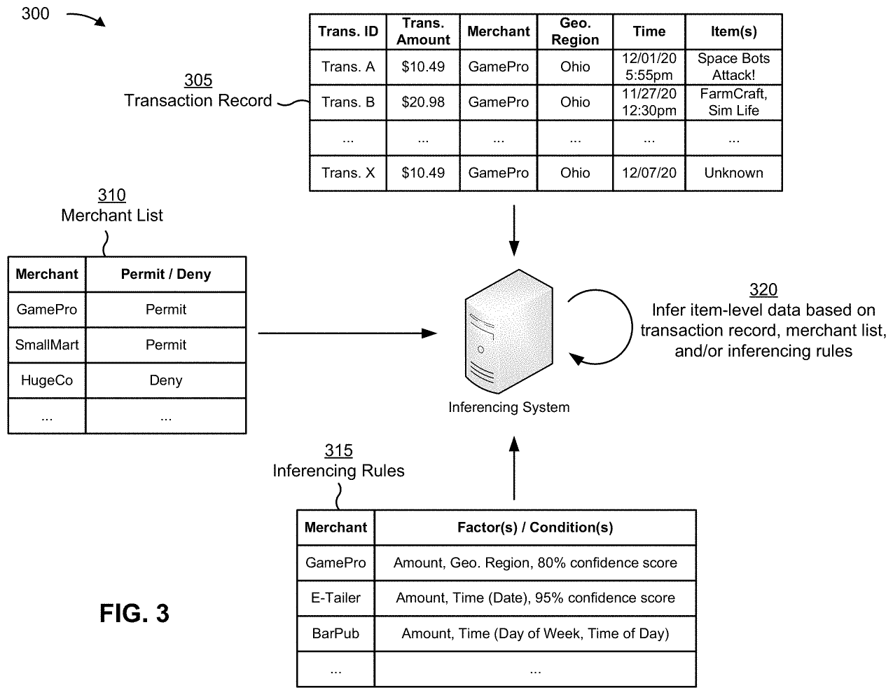

As shown by reference number 130, the inferencing system may output an indication of the inferred second item-level data associated with the second transaction. For example, the inferencing system may instruct the transaction storage system to replace the unknown item-level data for Transaction X with the inferred item-level data, such as “Video Game.” The inferred item-level data may then be used for any operation performed by the transaction storage system and/or using the transaction record. In some implementations, the inferencing system may determine whether to output an indication of inferred item-level data based on a confidence score, as described in more detail below in connection with FIG. 3. For example, the inferencing system may output the indication if the confidence score satisfies a threshold (e.g., is greater than or equal to the threshold). Otherwise, the inferencing system may refrain from outputting the indication of the inferred item-level data.

As an example, and as shown by reference number 135, a user may interact with a user device to log in to a website or application to view the user's account information, such as a history of transactions. Based on a request to view a transaction history, the transaction storage system may provide transaction information for an account of the user to the user device. The transaction information may include the inferred item-level data. As shown, the user device may provide the second item-level data for display in association with the second transaction (e.g., along with one or more other transactions, not shown). For example, rather than only displaying a transaction amount (e.g., $10.49) for Transaction X, which would be the case if the item-level data was not inferred, the user device also displays item-level data indicating that Transaction X was for a video game with a price of $9.99 and included sales tax of $0.50.

In some implementations, the transaction storage system may store an indication that the second item-level data was inferred. In this case, the transaction storage system may output an indication that the second item-level data has been inferred for the second transaction. Based on receiving this indication, the user device may output an indication that the second item-level data has been inferred, shown as “Inferred Item-Level Data.” This may assist a user in analyzing transaction information.

As further shown, in some implementations, the transaction storage system may output a request for a user to indicate whether the inferred item-level data is accurate and/or to modify the inferred item-level data. Based on receiving this request, the user device may provide, on an interface, an input mechanism that permits a user to provide input indicating that the second item-level data is accurate (shown as a “Correct” button), provide input indicating that the second item-level data is inaccurate (shown as an “Incorrect” button), and/or modify the second item-level data. The input mechanism may include one or more buttons that the user may click or touch, a text box or other mechanism for text input (e.g., on a text-based display) to confirm that the second item-level data is accurate and/or modify the second item-level data (e.g., by entering a correct category and/or one or more correct items). In some implementations, one input mechanism may trigger another input mechanism. For example, a button that the user may click (e.g., with a mouse) or touch (e.g., on a touchscreen) to indicate that the second item-level data is inaccurate (e.g., as shown in FIG. 1B) may trigger the display of a text box or other mechanism for text input to modify the second item-level data.

In some implementations, the user device may transmit user input to the transaction storage system, and the transaction storage system may update the transaction record based on the user input. For example, if the user confirms item-level data, then the transaction storage system may delete a stored indication that the item-level data has been inferred. As another example, if the user indicates that the item-level data is incorrect (but does not provide correct item-level data), then the transaction storage system may delete the item-level data and/or store an indication that the item-level data is incorrect (which may cause the transaction storage system to refrain from providing the item-level data to the user device based on a future request and/or may cause the user device to refrain from providing the incorrect item-level data for display). As another example, if the user input modifies the item-level data, then the transaction storage system may overwrite the inferred item-level data with the modified item-level data (and may delete a stored indication that the item-level data has been inferred, in some implementations). In some cases, if the user device outputs the item-level data and the user does not provide any input, this may be treated as an assumption that the item-level data is correct, and the user device may transmit an indication, to the transaction storage system, that the item-level data is correct.

When the transaction storage system receives new item-level data (e.g., as described in connection with reference number 110 of FIG. 1A), receives a confirmation of item-level data, and/or receives input to modify item-level data, the transaction storage system may notify the inferencing system. Based on this notification, the inferencing system may identify one or more transactions for which item-level data can be inferred from the new item-level data, the confirmed item-level data, and/or the modified item-level data. The inferencing system may identify the one or more transactions based on one or more rules described elsewhere herein (e.g., transaction amounts, merchants, geographic regions, and/or times that match and/or satisfy one or more conditions). In this way, the transaction record may be updated over time to become increasingly accurate and provide data that would otherwise be unavailable.

If information that the transaction storage system receives from the user device causes the transaction storage system to modify any information in the transaction record, then the transaction storage system may provide information that identifies the modified information to the inferencing system, which may re-infer item-level data for one or more transactions based on the modified information. For example, an indication that item-level data is correct may increase a confidence score for item-level data associated with one or more other transactions, and/or an indication that item-level data is incorrect may decrease a confidence score for item-level data associated with one or more other transactions. In some cases, the inferencing system may use a rule that indicates that inferred item-level data may not be used to infer other item-level data. In these cases, if the transaction storage system receives an indication that inferred item-level data is correct, then this item-level data may be used to infer other item-level data. As another example, item-level data that is modified based on user input may be treated as correct item-level data, and may be used to infer other item-level data. In some cases, this may result in different item-level data than a prior inference. In this way, inferences generated by the inferencing system may have increased accuracy and may be applied to an increasing number of transactions over time, thereby generating information that would otherwise be unavailable.

In some implementations, the transaction storage system may determine return data or warranty data associated with at least one item included in the second item-level data, and may provide the return data or the warranty data to the user device for display in association with the second item-level data. In some implementations, the transaction storage system may obtain the return data or the warranty data from one or more servers associated with a manufacturer of one or more items indicated by the second item-level data and/or one or more servers associated with a merchant indicated by the second transaction-level data, among other examples. The return data may indicate a time limit for returning an item (e.g., measured from the date of the transaction). The warranty data may indicate a time period during which an item is under warranty. Because return data and warranty data are associated with specific items (in item-level data) rather than a transaction as a whole, this data would otherwise not be available without the inferencing techniques described herein.

Although FIG. 1B shows inferred item-level data as being output to a user device for display, one or more other actions may be performed using the inferred item-level data. For example, the inferred item-level data may used for fraud detection. In this case, the inferencing system may provide the inferred item-level data as input (e.g., to a fraud detection system) for determination of a fraud score associated with the transaction. Because the item-level data can be inferred earlier than other techniques for determining item-level data (e.g., a user providing an image of a receipt), fraud can be detected earlier using the techniques described herein. As a result, computing resources can be conserved that would have otherwise been used to investigate and/or report the fraudulent activity. In some cases, fraud detection may be performed in connection with approving or denying a transaction, such as if the item-level data is inferred at the time of a transaction and provided as input to determine a fraud score that indicates whether to approve or deny the transaction. In this case, a financial institution and/or a merchant may conserve computing resources that would have otherwise been used to reverse the fraudulent activity for the user and/or to identify, detect, and diagnose the fraudulent activity.

Additionally, or alternatively, the inferred item-level data can be used to provide shopping recommendations and/or targeted advertising to a user (e.g., based on identifying items that are similar to or complement the inferred item-level data) and/or to identify and/or recommend promotions or financial products for a user (e.g., promotions or financial products that could result in savings for the user), among other examples.

As indicated above, FIGS. 1A-1B are provided as an example. Other examples may differ from what is described with regard to FIGS. 1A-1B.

FIGS. 2A-2B are diagrams of an example 200 associated with an inferencing system that infers item-level data using an inventory record. As shown in FIGS. 2A-2B, example 200 includes an inferencing system, which may be partially or wholly included in a transaction storage system, as described above in connection with FIGS. 1A-1B.

As shown by reference number 205, the inferencing system may receive an inventory record, such as from a server associated with a merchant and/or a data source that stores information regarding merchant inventories, among other examples. The inventory record may store item-level data for one or more items offered for sale by the merchant. For example, an entry in the inventory record may indicate a SKU associated with an item, a price of the item, a name of the item, and/or a category of the item (e.g., a product category or a service category). In some cases, an attribute of an item may make that item distinguishable in the transaction record, such as a price that is different from all other prices in the inventory record. In FIG. 2A, Item C is a distinguishable item because Item C has a price of $299.99 and no other items in the inventory record have a price of $299.99. The inferencing system may receive different inventory records from different merchants.

As shown by reference number 210, the inferencing system may receive transaction-level data, as described above in connection with FIGS. 1A-1B. As shown, the transaction-level data in FIG. 2A is for a transaction identified as Transaction Y, indicates a transaction amount of the transaction ($325.48), a merchant associated with the transaction (GamePro), a geographic region associated with the transaction (Ohio), and a time associated with the transaction (12/01/20, at 5:55 pm). The inferencing system may use the merchant identified in the transaction data to identify an inventory record corresponding to that merchant.

As shown by reference number 215, the inferencing system may receive tax data, such as from a server associated with a government entity and/or a data source that stores tax data for one or more geographic regions and/or government entities, among other examples. The tax data may indicate tax rates (e.g., sales tax rates, luxury tax rates, and/or value added tax (VAT) tax rates) for one or more geographic regions. For example, an entry of tax data may indicate a geographic region and a tax rate for that geographic region. In some implementations, an entry for a geographic region may include tax data for multiple tax jurisdictions, such as a first tax rate for a city indicated by the geographic region and a second tax rate for a state indicated by the geographic region. The inferencing system may receive and store different tax rates for different geographic regions.

As shown by reference number 220, when inferring item-level data for a transaction, the inferencing system may infer the item-level data based on the inventory record, the transaction-level data, and the tax data. For example, the inferencing system may determine a tax rate based on the geographic region associated with Transaction Y (e.g., a 5% tax rate for Ohio in FIG. 2A), and may subtract a tax amount from a transaction amount for Transaction Y based on the tax rate. In FIG. 2A, a 5% tax rate and a transaction amount of $325.48 corresponds to a total item amount (e.g., a sum of the prices of all purchased items, without tax) of $309.98 and a tax amount of $15.50. In some implementations, the inferencing system may solve one or more equations (e.g., a single equation or a system of equations) to determine the total item amount and the tax amount. For example, the inferencing system may solve the following system of equations:

Total Item Amount+Tax Amount=Transaction Amount

Tax Amount=Total Item Amount×Tax Rate

Alternatively, the inferencing system may solve the following equation to determine the total item amount (e.g., where the tax rate and transaction amount are known from the tax data and the transaction-level data):

Total Item Amount+(Total Item Amount×Tax Rate)=Transaction Amount

After determining the total item amount, the inferencing system may determine the tax amount as follows:

Tax Amount=Total Item Amount×Tax Rate

After subtracting the determined tax amount of $15.50 from the transaction amount of $325.48, the inferencing system may identify a single item from the inventory record with a price that matches the total item amount of $309.98, or a combination of items from the inventory record with a sum of prices that matches the total item amount of $309.98.

As shown by reference number 225, the inferencing system determines that the total item amount of $309.98 corresponds to a purchase of Console X with a price of $299.99 and a purchase of Video Game with a price of $9.99. In this case, the inferencing system determines that Transaction Y includes a first line item of Console X at $299.99, a second line item of Video Game at $9.99, and a third line item of Tax at $15.50. In this case, the distinguishable item of Console X is indicated with a product name, whereas the indistinguishable video game items are indicated with a product category. In this example, the video game category is a distinguishable category because all of the video games in the inventory record have the same price.

In some implementations, the inventory record may indicate different prices of the same item at different times. For example, the inventory record may include a first price for an item for a particular date (e.g., sale days and/or holidays), day of the week, and/or time (e.g., a time range with a different price, such as happy hour) and a second price for the item on another date and/or at another time. In this case, the inferencing system may use the time of the transaction, indicated in the transaction-level data, to determine one or more prices to be used when inferring item-level data.

In some cases, when the inferencing system can infer item-level data for some of the items in the transaction (e.g., distinguishable items), but cannot infer item-level data for other transactions (e.g., when items and categories are not distinguishable), the item-level data may indicate an item (or category) and price for one or more items, may indicate an amount for which item-level data could not be inferred, and/or may indicate the tax amount.

As shown in FIG. 2B, in some cases the inventory record and/or the tax data may identify taxed and/or untaxed items for a geographic region. For example, as shown by reference number 230, an entry in the inventory record may identify an item (e.g., using a SKU, an item name, or another identifier), a price of the item, and/or whether the item is taxed. As further shown, in some cases, the inventory record may include a limited inventory (e.g., less than or equal to a threshold number of entries or items) with distinguishable prices (e.g., where prices of different items are not multiples or divisors of each other).

As shown by reference number 235, the inferencing system may receive transaction-level data, as described above in connection with FIGS. 1A-1B. As shown, the transaction-level data in FIG. 2B is for a transaction identified as Transaction Z, indicates a transaction amount of the transaction ($28.39), a merchant associated with the transaction (Merchant B), and a geographic region associated with the transaction (Florida). In some implementations, the inferencing system may use the merchant identified in the transaction data to identify an inventory record corresponding to that merchant.

As shown by reference number 240, the inferencing system may receive tax data, as described above in connection with FIG. 2A. In some implementations, the tax data may indicate one or more categories of items that are untaxed (e.g., exempt from taxation) in a geographic region. Additionally, or alternatively, the tax data may indicate different tax rates for different categories of items in a geographic region.

As shown by reference number 245, when inferring item-level data for a transaction, the inferencing system may infer the item-level data based on the inventory record, the transaction-level data, and the tax data, in a similar manner as described above in connection with FIG. 2A. In some implementations, the inferencing system may determine an after-tax price for items in the inventory record, which may be different from the pre-tax price for taxed items and the same as the pre-tax price for untaxed items. The inferencing system may solve a system of equations using the after-tax prices for items in the inventory record to determine a combination of items that led to the transaction amount. In example 200, the inferencing system determines that a purchase of a single Item D at $5.99 plus a 7% tax of $0.42, a single Item E at $8.99 without tax, and a single Item F at $12.99 without tax results in the total transaction amount of $28.39. Because the prices of the items in the inventory record are distinguishable from one another (e.g., none of the prices are multiples or divisors of another price), the inferencing system determines that there are no other combinations of items that could result in this total transaction amount.

As shown by reference number 250, the inferencing system determines that Transaction Z includes a first line item of Item E at $8.99, a second line item of Item F at $12.99, a third line item of Item D at $5.99, and a fourth line item of Tax at $0.42. As further shown, the inferencing system may also output an indication of a first set of items in the item-level data that are untaxed (e.g., Items E and F) and a second set of items in the item-level data that are taxed (e.g., Item D). In some implementations, this information may be provided for display by the user device, in a similar manner as described in connection with FIG. 1B.

In some implementations, if the inventory record includes two or more items with prices that are not distinguishable, such as two items with the same price or a first item that has a price that is a multiple of or a divisor of a price of a second item, then the inferencing system may output an indication of item-level data for one or more items with prices that could be distinguished. For the remaining transaction amount that is not accounted for by those items, the inferencing system may output an indication that item-level data could not be determined for the remaining transaction amount. Alternatively, the inferencing system may indicate all possible combinations of items that result in the remaining transaction amount, and the user device may provide these combinations for display with a prompt for the user to indicate which items were actually purchased. Alternatively, the inferencing system may infer the item or items that resulted in the remaining transaction amount based on historical purchase data associated with an account for which the item-level data is being inferred, and/or based on the item-level data that could be inferred for the transaction (e.g., for items that are commonly purchased together, as determined from item-level data for one or more other transactions).

In some implementations, the tax data may indicate different taxable statuses for the same category of items at different times. For example, the tax data may include a first taxable status (e.g., taxed or untaxed) for an item category for a particular date and a second taxable status for the item category on another date to account for tax holidays and/or tax breaks. In this case, the inferencing system may use the time of the transaction (e.g., the date), indicated in the transaction-level data, to determine one or more after-tax prices to be used when inferring item-level data.

The techniques described in connection with FIGS. 2A and/or 2B may be applied to the first transaction-level data and/or the second transaction-level data described above in connection with FIGS. 1A-1B. For example, the inferencing system may use an inventory record and/or tax data to infer first item-level data from first transaction-level data, and may subsequently use the first item-level data to infer second item-level data from second transaction-level data (e.g., with or without using an inventory record to infer the second item-level data).

As indicated above, FIGS. 2A-2B are provided as an example. Other examples may differ from what is described with regard to FIGS. 2A-2B.

FIG. 3 is a diagram of an example 300 associated with an inferencing system that uses confidence scores to infer item-level data. The techniques described in connection with FIG. 3 may be used alone or in combination with one or more techniques described above in connection with FIGS. 1A, 1B, 2A, and/or 2B to infer item-level data.

As shown by reference number 305, the inferencing system may receive a transaction record that includes transaction-level data, as described elsewhere herein. As shown by reference number 310, the inferencing system may receive and/or may store a merchant list (e.g. from a server and/or based on operator input). The merchant list (or merchant data structure) may instruct the inferencing system regarding whether to infer item-level data for transactions conducted with a merchant included in the merchant list. For example, an entry in the merchant list may identify a merchant (e.g., using a merchant identifier) and may include an instruction for the inferencing system regarding whether to infer item-level data for that merchant (shown as Permit and Deny).

In some implementations, the inferencing system or another system may determine whether to permit or deny an inference of item-level data for a merchant. The inferencing system may make this determination based on a number of items included in an inventory of a merchant, a number of distinguishable items or prices included in an inventory of the merchant, and/or a number of indistinguishable items or prices included in an inventory of the merchant, among other examples. The inferencing system may determine these numbers based on analyzing an inventory record of the merchant and/or based on receiving item-level data for multiple transactions with the merchant (e.g., which may be used to construct an inventory record).

For example, the inferencing system may store an indication to deny an inference of item-level data for a merchant if that merchant is associated with a number of items and/or item categories (e.g., in inventory) that satisfies a threshold, is associated with a number of indistinguishable items and/or item categories (items and/or item categories having distinguishable prices) that satisfies a threshold, and/or is associated with a number of distinguishable items and/or item categories (items and/or item categories having indistinguishable prices) that does not satisfy a threshold. As another example, the inferencing system may store an indication to permit an inference of item-level data for a merchant if that merchant is associated with a number of items and/or item categories that does not satisfy a threshold, is associated with a number of indistinguishable items and/or item categories that does not satisfy a threshold, and/or is associated with a number of distinguishable items and/or item categories that satisfies a threshold. In this way, the inferencing system may conserve resources (e.g., computing resources, processor resources, and/or memory resources) by refraining from attempting to infer item-level data for merchants that are associated with a low likelihood of successfully inferring item-level data.

As shown by reference number 315, the inferencing system may receive and/or store a set of inferencing rules (e.g. from a server and/or based on operator input). In some implementations, an inferencing rule may be specific to a merchant. Alternatively, an inferencing rule may apply to all merchants and/or multiple merchants. An inferencing rule may indicate one or more factors that the inferencing system is to use to infer item-level data. A factor may include, for example, one or more parameters included in transaction-level data, an inventory record, and/or tax data. In some implementations, the inferencing system may learn an inferencing rule, as described below in connection with FIG. 4.

As shown by reference number 320, the inferencing system may infer item-level data for a transaction based on transaction-level data, a merchant list, and/or inferencing rules, as described above. Additionally, or alternatively, the inferencing system may infer item-level data for a transaction based on provided item-level data, an inventory record, and/or tax data, as described elsewhere herein. As shown in FIG. 3 and as an example, a transaction amount is used as a factor to infer item-level data for all merchants. As further shown and as another example, a geographic region is used as a factor to infer item-level data for a multi-region retailer (e.g., GamePro) but not for an online retailer (e.g., E-Tailer) or a single-region retailer (e.g., BarPub). As further shown and as another example, a date is used as a factor to infer item-level data for an online retailer with prices that may fluctuate at different dates (e.g., E-Tailer) and a retailer with seasonal prices (e.g., BarPub), but not a retailer with relatively stable prices (e.g., GamePro). As further shown and as another example, time of day is used as a factor to infer item-level data for a retailer with time-based pricing (e.g., BarPub) but not for a retailer without time-based pricing (e.g., GamePro and E-Tailer).

In some implementations, a rule may indicate a confidence score required for inferred item-level data to be stored and/or output (e.g., to a user device, as described elsewhere herein). A confidence score may indicate a degree of confidence in inferred item-level data (e.g., a likelihood that the inferred item-level data is correct). The inferencing system may determine the confidence score for inferred item-level data based on, for example, whether the inferencing system has access to and/or stores an inventory record for a merchant, whether the inventory record was used to infer the item-level data, one or more characteristics of the inventory record (e.g., a number of items and/or item categories in the inventory record, a number of distinguishable items and/or item categories in the inventory record, and/or number of indistinguishable items and/or item categories in the inventory record), and/or a number of transactions with matching transaction data or with transaction data that satisfies a condition (as described above), among other examples. In some implementations, the confidence score may be based on a quantity of transactions for which respective merchants match the merchant of a transaction for which item-level data is being inferred. Additionally, or alternatively, the confidence score may be based on a quantity of transactions for which respective transaction amounts match the transaction amount of the transaction or satisfy a condition that is based on the transaction amount of the transaction.

The inferencing system may determine an overall confidence score and/or an individual confidence score. An individual confidence score is a confidence score for a particular inferred line item, whereas an overall confidence score is for all line items inferred for a transaction. The inferencing system may determine an overall confidence score for a transaction based on the individual confidence scores for the line items of the transaction (e.g., an average, a mean, and/or a median). In some implementations, the inferencing system may store and/or output inferred item-level data for a transaction if the overall confidence score for that transaction satisfies a threshold (e.g., 80% or 95%, as shown in FIG. 3). Additionally, or alternatively, the inferencing system may store and/or output inferred item-level data for a line item of the transaction if an individual confidence score for that line item satisfies a threshold. In this case, the inferencing system may store and/or output an indication that inferred line-item data does not satisfy a confidence score for a remaining transaction amount (e.g., after accounting for the line items with confidence scores that satisfy a threshold).

Additionally, or alternatively, the inferencing system may determine a classification label to be output for inferred item-level data based on a confidence score associated with the inferred item-level data. Different classification labels for a line item may be associated with different degrees of specificity for describing the line item. In some implementations, a line item may be associated with a set of classification labels (e.g., stored in memory of the inferencing system), and the inferencing system may select a classification label from the set of classification labels based on the confidence score. A particular classification label may be associated with one or more confidence score thresholds used for the selection. In example 300, a required confidence score to select an item category of “Video Game” may be lower than a required confidence score to select an item of “Space Bots Attack!” or “Sim Life” or “FarmCraft” for inferred item-level data. In this way, item-level data inferred by the inferencing system may be more accurate.

As indicated above, FIG. 3 is provided as an example. Other examples may differ from what is described with regard to FIG. 3.

FIG. 4 is a diagram illustrating an example 400 of training and using a machine learning model in connection with inferring item-level data using rule-based reasoning. The machine learning model training and usage described herein may be performed using a machine learning system. The machine learning system may include or may be included in a computing device, a server, and/or a cloud computing environment, such as the inferencing system 501 described in more detail elsewhere herein.

As shown by reference number 405, a machine learning model may be trained using a set of observations. The set of observations may be obtained from historical data, such as data gathered during one or more processes described herein. In some implementations, the machine learning system may receive the set of observations (e.g., as input) from one or more transaction terminals and/or one or more transaction records.

As shown by reference number 410, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a data source, as described elsewhere herein. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of transaction amount, a second feature of geographic region, a third feature of transaction time, and so on. As shown, for a first observation, the first feature may have a value of “$10.49”, the second feature may have a value of “Ohio”, the third feature may have a value of “12/01/20 at 5:55 pm”, and so on. These features and feature values are provided as examples, and may differ in other examples. For example, the feature set may include one or more of the following features: merchant, time of day, item category, inventory record data (e.g., price and/or taxable status for an item), and/or tax data (e.g., tax rate and/or taxable status for an item category). In some implementations, the features to be used to train and/or use the machine learning model may be based on factors indicated in an inferencing rule.

As shown by reference number 415, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes and/or classifications, labels), and/or may represent a variable having a Boolean value, among other examples. A target variable may be associated with a target variable value, and a target variable value may be specific to an observation. In example 400, the target variable is item-level data, which has a value of “Space Bots Attack!” for the first observation. In some implementations, the target variable may include classification labels at different levels of specificity. For example, the item-level data for the first observation may include a category of Video Game in addition to or instead of the item “Space Bots Attack!”. Accordingly, the machine learning model may be trained to varying levels of specificity for the target variable.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 420, the machine learning system may train a machine learning model using the set of observations and using one or more machine learning algorithms, such as a regression algorithm, a decision tree algorithm, a neural network algorithm, a k-nearest neighbor algorithm, and/or a support vector machine algorithm. After training, the machine learning system may store the machine learning model as a trained machine learning model 425 to be used to analyze new observations.

As shown by reference number 430, the machine learning system may apply the trained machine learning model 425 to a new observation, such as by receiving a new observation and inputting the new observation to the trained machine learning model 425. As shown, the new observation may include a first feature of a transaction amount, a second feature of a geographic region, a third feature of a transaction time, and so on, as an example. The machine learning system may apply the trained machine learning model 425 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 425 may predict a value of “Video Game” for the target variable of item-level data for the new observation, as shown by reference number 435. Based on this prediction, the machine learning system may provide a recommendation, may provide output for determination of a recommendation, may perform an automated action, and/or may cause an automated action to be performed (e.g., by instructing another device to perform the automated action). The recommendation may include, for example, a prompt to confirm the predicted value and/or a prompt to reduce spending on the predicted item-level data. The automated action may include, for example, determining return information and/or warranty information associated with the item-level data.

In some implementations, the trained machine learning model 425 may classify (e.g., cluster) the new observation in a cluster, as shown by reference number 440. The observations within a cluster may have a threshold degree of similarity. As an example, if the machine learning system classifies the new observation in a first cluster (e.g., a category of Video Game), then the machine learning system may provide a first output (e.g., a corresponding classification label). As another example, if the machine learning system were to classify the new observation in a second cluster (e.g., Video Game Console), then the machine learning system may provide a second (e.g., different) output (e.g., a corresponding classification label).

In some implementations, the output (and/or recommendation and/or the automated action) associated with the new observation may be based on a target variable value having a particular label (e.g., classification and/or categorization), may be based on whether a target variable value satisfies one or more thresholds (e.g., whether the target variable value is greater than a threshold, is less than a threshold, is equal to a threshold, and/or falls within a range of threshold values), and/or may be based on a cluster in which the new observation is classified.

In this way, the machine learning system may apply a rigorous and automated process to inferring item-level data. The machine learning system enables recognition and/or identification of tens, hundreds, thousands, or millions of features and/or feature values for tens, hundreds, thousands, or millions of observations, thereby increasing accuracy and consistency and reducing delay associated with inferring item-level data relative to requiring computing resources to be allocated for tens, hundreds, or thousands of operators to manually inferring item-level data using the features or feature values.

Although described above in connection with a single model, the trained machine learning model 425 may include multiple models (e.g., associated with different merchants, as described above in connection with FIG. 3) such that one of the models is selected for the new observation before prediction and/or classification (e.g., as described above). As an alternative, the trained machine learning model 425 may comprise a metamodel that performs prediction and/or classification (e.g., as described above) using different models within the metamodel based at least in part on a feature within the new observation (e.g., a merchant indicated by the new observation).

As indicated above, FIG. 4 is provided as an example. Other examples may differ from what is described in connection with FIG. 4.

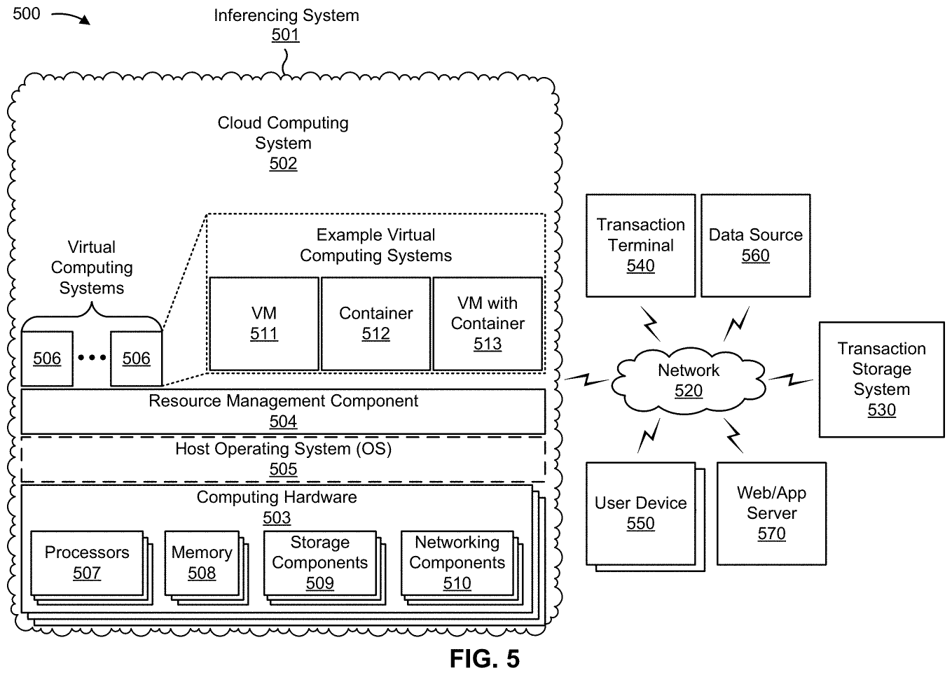

FIG. 5 is a diagram of an example environment 500 in which systems and/or methods described herein may be implemented. As shown in FIG. 5, environment 500 may include an inferencing system 501, which may include one or more elements of and/or may execute within a cloud computing system 502. The cloud computing system 502 may include one or more elements 503-513, as described in more detail below. As further shown in FIG. 5, environment 500 may include a network 520, a transaction storage system 530, a transaction terminal 540, a user device 550, a data source 560, and/or a website or application server 570. Devices and/or elements of environment 500 may interconnect via wired connections and/or wireless connections.

The cloud computing system 502 includes computing hardware 503, a resource management component 504, a host operating system (OS) 505, and/or one or more virtual computing systems 506. The resource management component 504 may perform virtualization (e.g., abstraction) of computing hardware 503 to create the one or more virtual computing systems 506. Using virtualization, the resource management component 504 enables a single computing device (e.g., a computer, a server) to operate like multiple computing devices, such as by creating multiple isolated virtual computing systems 506 from computing hardware 503 of the single computing device. In this way, computing hardware 503 can operate more efficiently, with lower power consumption, higher reliability, higher availability, higher utilization, greater flexibility, and lower cost than using separate computing devices.

Computing hardware 503 includes hardware and corresponding resources from one or more computing devices. For example, computing hardware 503 may include hardware from a single computing device (e.g., a single server) or from multiple computing devices (e.g., multiple servers), such as multiple computing devices in one or more data centers. As shown, computing hardware 503 may include one or more processors 507, one or more memories 508, one or more storage components 509, and/or one or more networking components 510. Examples of a processor, a memory, a storage component, and a networking component (e.g., a communication component) are described elsewhere herein.

The resource management component 504 includes a virtualization application (e.g., executing on hardware, such as computing hardware 503) capable of virtualizing computing hardware 503 to start, stop, and/or manage one or more virtual computing systems 506. For example, the resource management component 504 may include a hypervisor (e.g., a bare-metal or Type 1 hypervisor, a hosted or Type 2 hypervisor) or a virtual machine monitor, such as when the virtual computing systems 506 are virtual machines 511. Additionally, or alternatively, the resource management component 504 may include a container manager, such as when the virtual computing systems 506 are containers 512. In some implementations, the resource management component 504 executes within and/or in coordination with a host operating system 505.

A virtual computing system 506 includes a virtual environment that enables cloud-based execution of operations and/or processes described herein using computing hardware 503. As shown, a virtual computing system 506 may include a virtual machine 511, a container 512, or a hybrid environment 513 that includes a virtual machine and a container, among other examples. A virtual computing system 506 may execute one or more applications using a file system that includes binary files, software libraries, and/or other resources required to execute applications on a guest operating system (e.g., within the virtual computing system 506) or the host operating system 505.

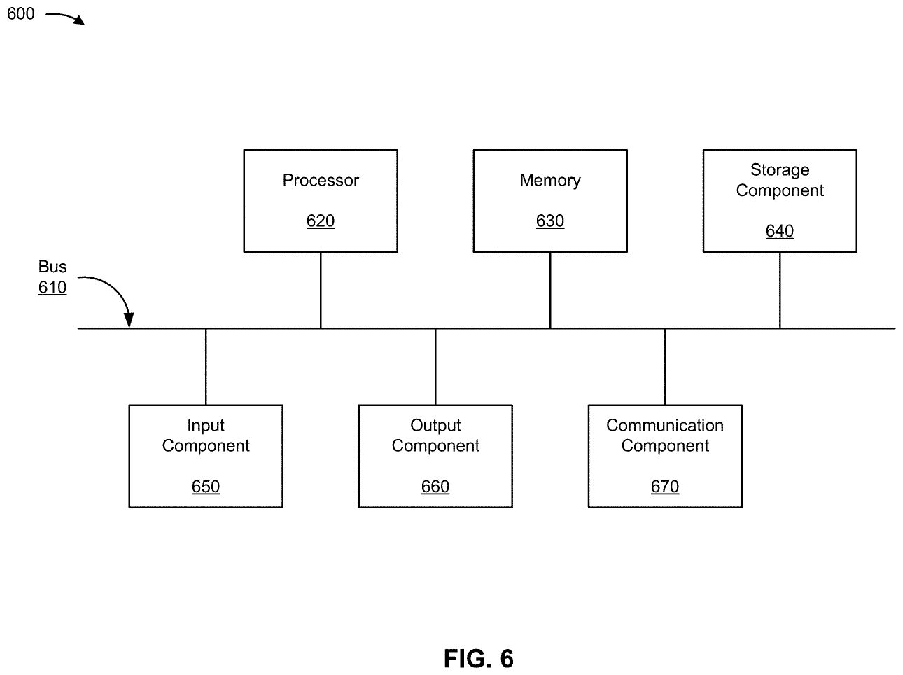

Although the inferencing system 501 may include one or more elements 503-513 of the cloud computing system 502, may execute within the cloud computing system 502, and/or may be hosted within the cloud computing system 502, in some implementations, the inferencing system 501 may not be cloud-based (e.g., may be implemented outside of a cloud computing system) or may be partially cloud-based. For example, the inferencing system 501 may include one or more devices that are not part of the cloud computing system 502, such as device 600 of FIG. 6, which may include a standalone server or another type of computing device. The inferencing system 501 may perform one or more operations and/or processes described in more detail elsewhere herein.

Network 520 includes one or more wired and/or wireless networks. For example, network 520 may include a cellular network, a public land mobile network (PLMN), a local area network (LAN), a wide area network (WAN), a private network, the Internet, and/or a combination of these or other types of networks. The network 520 enables communication among the devices of environment 500.

The transaction storage system 530 may be implemented on a cloud computing system at least partially integrated with cloud computing system 502 or distinct from cloud computing system 502. In some implementations, the transaction storage system 530 may include one or more devices that are not part of a cloud computing system, such as device 600 of FIG. 6, which may include a standalone server or another type of computing device. The transaction storage system 530 may receive and store transaction-level data, as described elsewhere herein.

The transaction terminal 540 includes one or more devices capable of facilitating a transaction. For example, the transaction terminal 540 may include a point-of-sale (PoS) terminal, a payment terminal (e.g., a credit card terminal, a contactless payment terminal, a mobile credit card reader, a chip reader, etc.), a security access terminal, and/or an automated teller machine (ATM) terminal. In some implementations, the transaction terminal 540 may communicate with the inferencing system 501 to provide, to the inferencing system 501 and/or the transaction storage system 530, information related to a transaction, such as transaction-level data.

The user device 550 includes one or more devices capable of receiving, generating, storing, processing, and/or providing information associated with a transaction. The user device 550 may include a communication device and/or a computing device. For example, the user device 550 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. In some implementations, the user device 550 may include an electronic wallet, an electronic payment application, or another type of transaction application that enables the user device 550 to perform and/or complete a transaction. The user device 550 may transmit item-level data (e.g., to transaction storage system 530). Additionally, or alternatively, the user device 550 may receive inferred item-level data and may output information associated with the inferred item-level data, as described elsewhere herein.

The data source 560 includes one or more devices capable of receiving, generating, storing, processing, and/or providing item-level data (e.g., using an inventory record, as described above in connection with FIGS. 2A-2B), tax data (e.g., as described above in connection with FIGS. 2A-2B), and/or other data described herein. The data source 560 may include a communication device and/or a computing device. For example, the data source 560 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The website or application server 570 includes one or more devices capable of receiving, generating, storing, processing, providing, and/or routing transaction-level data (e.g., from transaction storage system 530) and/or inferred item-level data (e.g., from inferencing system 501). The website or application server 570 may include a communication device and/or a computing device. For example, the website or application server 570 may include a server, an application server, a client server, a web server, a database server, a host server, a proxy server, a virtual server (e.g., executing on computing hardware), a server in a cloud computing system, a device that includes computing hardware used in a cloud computing environment, or a similar type of device. In some implementations, the website or application server 570 may receive inferred item-level data and/or transaction data from the transaction storage system 530 and/or the inferencing system 501, and may provide such data for presentation via the user device 550.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600, which may correspond to inferencing system 501, transaction storage system 530, transaction terminal 540, user device 550, data source 560, and/or website or application server 570. In some implementations, transaction storage system 530, transaction terminal 540, user device 550, data source 560, and/or website or application server 570 may include one or more devices 600 and/or one or more components of device 600. As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid state disk drive, a compact disc, a digital versatile disc, and/or another type of non-transitory computer-readable medium. Input component 650 enables device 600 to receive input, such as user input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 600 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

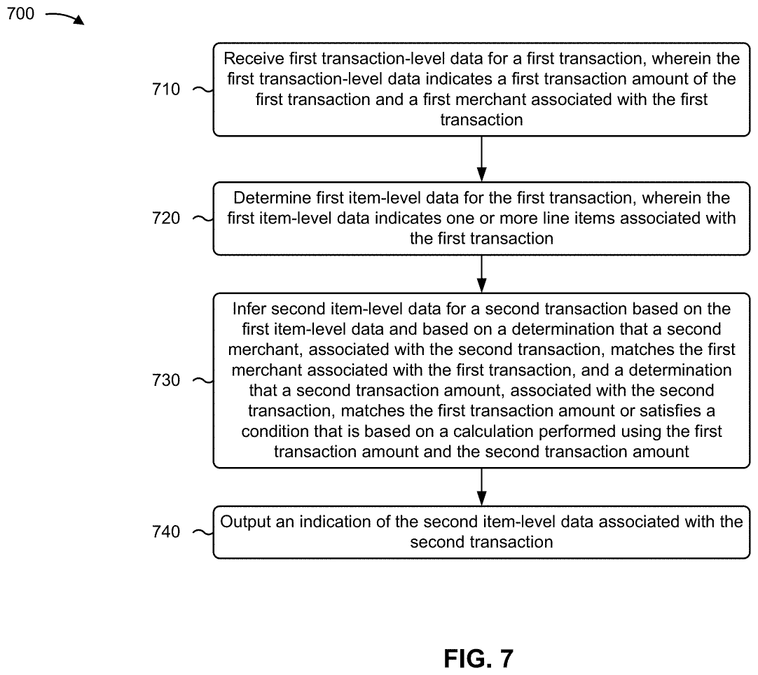

FIG. 7 is a flowchart of an example process 700 associated with inferring item-level data with backward chaining rule-based reasoning systems. In some implementations, one or more process blocks of FIG. 7 may be performed by a system (e.g., inferencing system 501). In some implementations, one or more process blocks of FIG. 7 may be performed by another device or a group of devices separate from or including the system, such as a transaction storage system, a transaction terminal, a user device, a data source, and/or a website or application server. Additionally, or alternatively, one or more process blocks of FIG. 7 may be performed by one or more components of device 600, such as processor 620, memory 630, storage component 640, input component 650, output component 660, and/or communication component 670.

As shown in FIG. 7, process 700 may include receiving first transaction-level data for a first transaction (block 710). As further shown in FIG. 7, process 700 may include determining first item-level data for the first transaction (block 720). As further shown in FIG. 7, process 700 may include inferring second item-level data for a second transaction based on the first item-level data and based on: a determination that a second merchant, associated with the second transaction, matches the first merchant associated with the first transaction, and a determination that a second transaction amount, associated with the second transaction, matches the first transaction amount or satisfies a condition that is based on a calculation performed using the first transaction amount and the second transaction amount (block 730). As further shown in FIG. 7, process 700 may include outputting an indication of the second item-level data associated with the second transaction (block 740). Additional details regarding blocks 710-740 are described above in connection with FIGS. 1A, 1B, 2A, 2B, and 3.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, etc., depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a system, first transaction-level data for a first transaction,
wherein the first transaction-level data indicates a first transaction amount of the first transaction and a first merchant associated with the first transaction;
determining, by the system, first item-level data for the first transaction,
wherein the first item-level data indicates one or more line items associated with the first transaction;
inferring, by the system, second item-level data for a second transaction based on the first item-level data and based on:
a determination that a second merchant, associated with the second transaction, matches the first merchant associated with the first transaction, and
a determination that a second transaction amount, associated with the second transaction, matches the first transaction amount or satisfies a condition that is based on a calculation performed using the first transaction amount and the second transaction amount; and
outputting, by the system, an indication of the second item-level data associated with the second transaction.

2. The method of claim 1, wherein the first transaction-level data further indicates a first geographic region associated with the first transaction; and
wherein the second item-level data is inferred further based on a determination that a second geographic region, associated with the second transaction, matches the first geographic region.

3. The method of claim 1, wherein the first transaction-level data further indicates a first transaction time associated with the first transaction; and
wherein the second item-level data is inferred further based on a determination that a second transaction time, associated with the second transaction, satisfies a condition associated with the first transaction time.

4. The method of claim 1, wherein outputting the indication of the second item-level data comprises providing the second item-level data for display in association with the second transaction.

5. The method of claim 4, further comprising outputting an indication that the second item-level data has been inferred for the second transaction.

6. The method of claim 4, further comprising providing, for display, an input mechanism that permits a user to:
confirm that the second item-level data is accurate,
provide input indicating that the second item-level data is inaccurate, or
modify the second item-level data.

7. The method of claim 1, further comprising:
determining return data or warranty data associated with an item included in the second item-level data; and
providing the return data or the warranty data for display in association with the second item-level data.

8. The method of claim 1, wherein the first transaction is included in a plurality of transactions associated with a corresponding plurality of merchants and a corresponding plurality of transaction amounts, and wherein the second item-level data is inferred based on:
a determination that the second merchant matches the plurality of merchants, and
a determination that the second transaction amount matches the plurality of transaction amounts or satisfies a condition that is based on one or more calculations performed using the plurality of transaction amounts and the second transaction amount.

9. The method of claim 1, wherein determining the first item-level data for the first transaction comprises:
determining that the first merchant is associated with an inventory record from which the first item-level data is inferable; and
determining the first item-level data based on the inventory record, based on the first transaction-level data, and based on determining that the first merchant is associated with the inventory record from which the first item-level data is inferable,
wherein the one or more line items included in the first item-level data identify at least one of a product, a product category, a service, a service category, or a tax amount.

10. A system, comprising:
one or more memories; and
one or more processors, communicatively coupled to the one or more memories, configured to:
receive first transaction-level data for a first transaction,
wherein the first transaction-level data indicates a first transaction amount of the first transaction, a first merchant associated with the first transaction, and a first geographic region associated with the first transaction;
identify a second transaction based on a determination that a second merchant associated with the second transaction, a second transaction amount associated with the second transaction, and a second geographic region associated with the second transaction satisfy a condition that is based on the first merchant, the first transaction amount, and the first geographic region;
infer second item-level data associated with the second transaction based on first item-level data associated with the first transaction; and
output an indication of the second item-level data associated with the second transaction.

11. The system of claim 10, wherein the first transaction-level data further indicates a first transaction time associated with the first transaction; and
wherein the second transaction is identified further based on a determination that a second transaction time associated with the second transaction satisfies the condition,
wherein the condition is further based on the first transaction time.

12. The system of claim 10, wherein the condition includes a first condition that indicates that the second transaction amount matches the first transaction amount or a second condition that indicates that the second transaction amount is a multiple of or a divisor of the first transaction amount after subtracting a first tax amount from the first transaction amount and subtracting a second tax amount from the second transaction amount.

13. The system of claim 10, wherein the one or more processors are further configured to:
determine that a confidence score, associated with inferring the second item-level data, satisfies a threshold; and
wherein the indication is output based on determining that the confidence score satisfies the threshold.

14. The system of claim 13, wherein the confidence score is based on a quantity of transactions for which respective merchants match the second merchant and for which respective transaction amounts match the second transaction amount or satisfy a condition that is based on the second transaction amount.

15. The system of claim 10, wherein the one or more processors are further configured to:
determine a confidence score associated with inferring the second item-level data;
select a classification label, from a set of classification labels, for the second item-level data based on the confidence score,
wherein different classification labels included in the set of classification labels describe an item in the second item-level data with a different degree of specificity; and
wherein the one or more processors, when outputting the indication of the second item-level data, are configured to output the classification label.

16. A non-transitory computer-readable medium storing a set of instructions, the set of instructions comprising:
one or more instructions that, when executed by one or more processors of a system, cause the system to:
receive first transaction-level data and first item-level data for a first transaction,
wherein the first transaction-level data indicates a first transaction amount of the first transaction and a first merchant associated with the first transaction, and
wherein the first item-level data indicates one or more line items associated with the first transaction;
receive second transaction-level data for a second transaction,
wherein the second transaction-level data indicates a second transaction amount of the second transaction and a second merchant associated with the second transaction;
infer second item-level data for the second transaction based on the first item-level data and based on a determination that a condition, that is based on the first transaction-level data and the second transaction-level data, is satisfied; and
output an indication of the second item-level data inferred for the second transaction.

17. The non-transitory computer-readable medium of claim 16, wherein the first transaction-level data further indicates a first geographic region associated with the first transaction and a first transaction time associated with the first transaction,
wherein the second transaction-level data further indicates a second geographic region associated with the second transaction and a second transaction time associated with the second transaction, and
wherein the condition is based on the first transaction amount, the second transaction amount, the first merchant, the second merchant, the first geographic region, the second geographic region, the first transaction time, and the second transaction time.

18. The non-transitory computer-readable medium of claim 16, wherein the one or more line items each identify at least one of a product, a product category, a service, a service category, or a tax amount.

19. The non-transitory computer-readable medium of claim 16, wherein the one or more instructions, that cause the system to output the indication of the second item-level data, cause the system to provide the second item-level data for display in association with the second transaction.

20. The non-transitory computer-readable medium of claim 16, wherein the first transaction is associated with a first account and the second transaction is associated with a second account.
